(19) United States
(12) Patent Application Publication
(10) Pub. No.: US 2023/0297084 A1
(43) Pub. Date: Sep. 21, 2023

(54) Automatic Configuration of Field Devices for an Industrial Plant

(71) Applicant: ABB Schweiz AG, Baden (CH)

(72) Inventors: Dirk Wagener, Stadthagen (DE); Marcus Heege, Kaisersesch (DE); Christoph Welte, Neu-Ulm (DE); Christian Fahrenholz, Memmingen (DE)

(73) Assignee: ABB Schweiz AG, Baden (CH)

(21) Appl. No.: 18/186,519

(22) Filed: Mar. 20, 2023

(30) Foreign Application Priority Data
Mar. 21, 2022 (EP) 22163180.7

(51) Int. Cl. G05B 19/418

(52) U.S. Cl. CPC G05B 19/4185; G05B 19/41845

(57) ABSTRACT

A system and method for configuring a field device for use in an industrial plant includes creating, from device description information of the field device, and/or from a template configuration, T, stored in association with the field device and/or in association with a type of the field device, an instance of a configuration for the field device; setting values of configuration parameters in the instance to default values given by the device description information, and/or to values given by the template T; determining semantic meanings of configuration parameters in the instance; obtaining, from a data store, values of configuration parameters stored in association with the field device and semantic meanings; writing each value obtained from the data store to a configuration parameter in the instance whose semantic meaning matches the semantic meaning of the value; and provisioning the field device with the instance of the configuration.

### CROSS-REFERENCE TO RELATED APPLICATIONS

This patent application claims priority to European Patent Application No. 22163180.7, filed on Mar. 21, 2022, which is incorporated herein in its entirety by reference.

### FIELD OF THE DISCLOSURE

The present disclosure relates to the configuration of field devices in industrial plants and, more particularly, to the bulk configuration of many field devices.

### BACKGROUND OF THE INVENTION

Industrial plants for executing industrial processes comprise a plurality of field devices that are connected to a distributed control system, DCS, via a network of the industrial plant. Field devices need to be configured before they can perform their intended function in the industrial plant. WO 2021/249 655 A1 discloses a method to configure a field device based on an OPC UA server of an already configured field device of the same type.

Configuration of a field device is usually performed manually by means of a user interface defined by an Electronic Device Description, EDD, or Device Package, DP, of the field device.

### BRIEF SUMMARY OF THE INVENTION

In a general aspect, the present disclosure at least partially automates the configuration of a field device, and also provides a computer-implemented method for configuring a field device for use in an industrial plant.

The method starts with creating an instance of a configuration for the field device. This instance defines a set of configuration parameters and stores values of these configuration parameters. In particular, each configuration parameter may be labelled with a name that serves as a “handle” for accessing this configuration parameter. The instance is created from device description information of the field device, and/or from a template configuration, T, stored in association with the field device and/or in association with a type of the field device. In particular, the device description information may comprise an Electronic Device Description, EDD, and/or a Device Package, DP, of the field device.

Values of configuration parameters in the instance are set to default values given by the device description information, and/or to values given by the template T. The main difference between default values given by the device description information on the one hand, and values given by the template T on the other hand, is that default values given by the device description information are provided by the device manufacturer, whereas the parameters of a template are provided by the plant operator. In particular, EDDs and DPs as device description information are industry standards for describing the functionality of field devices. One and the same field device may be used in many types of industrial plants, but the field device will always have the same EDD and/or DP. The field device may be shipped with an EDD and/or DP, but the EDD and/or DP may also be supplied or updated later by the manufacturer of the field device.

By contrast, the values given by the template T are specific to the field device and/or to a type of field device, but also to the industrial plant where it is being used. In particular, a template T may be created by a plant operator who installs a plurality of field devices of the same type, and it may store values of configuration parameters that need to be set to the same value in many field devices. For example, field devices may have an option to either reboot automatically or wait for an operator to press a physical key before rebooting, and this option may need to be set to “reboot automatically” in all field devices in the industrial plant. Also, field devices that handle fresh water from the waterworks may need to know the degree of water hardness, which is common to all field devices in this particular plant.

The device description information, and/or the template T, may already populate many of the configuration parameters of the field device with values. But at least some configuration parameter values are specific to each individual field device. To also populate these configuration parameters with values, and/or to override already set configuration parameters with new values, semantic meanings of configuration parameters in the instance are determined. From a data store, values of configuration parameters stored in association with the to-be-configured field device and semantic meanings are obtained. The association with the to-be-configured field device may, for example, be established via a name or other identifier of the field device that is stored together with the values of configuration parameters and their semantic meanings in the data store.

Each value obtained from the data store is written to a configuration parameter in the instance whose semantic meaning matches the semantic meaning of the value from the data store. The field device is then provisioned with the instance of the configuration.

Names of configuration parameters for field devices are unique identifiers for these configuration parameters, but they are not standardized. Rather, every manufacturer of field devices is free to assign names in any manner he deems fit. For example, a pressure set-point may be named “pset” in one field device, “set-p” in another and “p-set-bar” in a third. The names may even change with later revisions or updates to the field device.

Therefore, when configuration parameters are stored in the data store in association with their names, the operator who inputs the configuration parameters needs to know which field device is in use and on which revision or update level it is. If the operator does not have this information or it is no longer accurate, he may reference the configuration parameters with a wrong name that the to-be-configured field device does not know. The same may happen if the operator mixes up field devices that use different nomenclatures for their configuration parameters when entering values for several different field devices of the same type. The result is that, when the field device is provisioned with the instance of the configuration, a configuration parameter that is set to a particular value in the instance will not be written to the field device. The field device will operate with a different value for that configuration parameter, or even refuse to start if the missing value of the configuration parameter is a value that is required for the startup. This is particularly disadvantageous if the actual provisioning is done as an unattended job, e.g., at nighttime in bulk for many field devices.

By contrast, when configuration parameters are referenced with their semantic meaning such as “pressure set-point” in the data store, the stored values will be written to exactly the configuration variable in the instance whose semantic meaning resolves to the semantic meaning of this value. This eliminates the sources for error mentioned above, causing the automatic configuration of field devices to become more reliable. Moreover, the data store is better readable and interpretable for the plant operator. For example, a table showing the content of the data store may be sorted by the column “semantic meaning”, and all values that relate to the semantic meaning “pressure set-point” will show up in one block. Sorting by names of configuration parameters would be far less meaningful because even names that ultimately resolve to the same semantic meaning may be scattered all across the alphabet.

### BRIEF DESCRIPTION OF THE SEVERAL VIEWS OF THE DRAWING(S)

FIG. 1 is a flowchart for a method for configuring a field device for use in an industrial plant in accordance with the disclosure.

FIG. 2 is a diagram of an exemplary setting where the method shown in FIG. 1 may be employed.

### DETAILED DESCRIPTION OF THE INVENTION

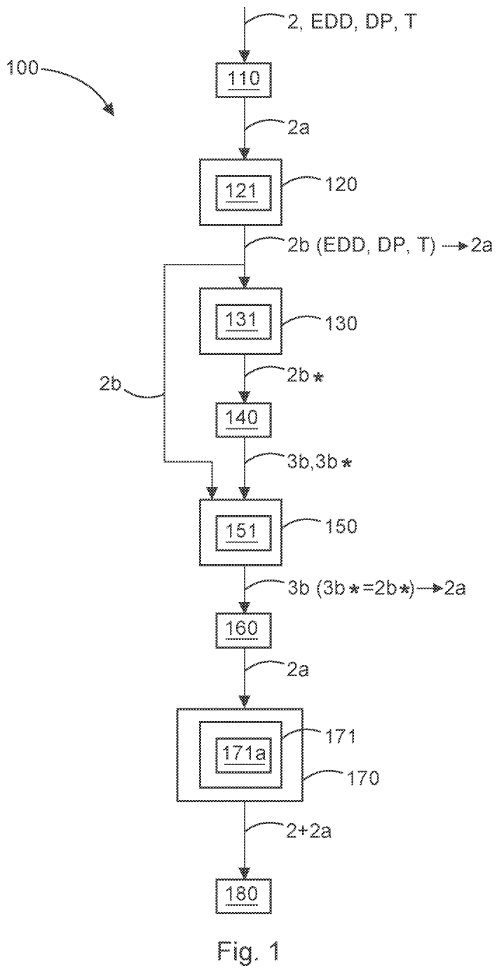

FIG. 1 is a schematic flow chart of an embodiment of the method 100 for configuring a field device 2 for use in an industrial plant 1. In step 110, an instance 2a of a configuration for the field device 2 is created from device description information of the field device 2, and/or a template configuration, T, stored in association with the field device 2 and/or in association with a type of the field device 2.

In the example shown in FIG. 1, the device description information comprises as an Electronic Device Description, EDD, and/or a Device Package, DP, of the field device 2. But the device description information may also come in any other suitable form or format.

In step 120, values of configuration parameters 2b in the instance 2a are set to default values given by the EDD and/or the DP, and/or to values given by the template T. Herein, according to block 121, for one and the same configuration parameter 2b, a value obtained from the template T may take precedence over a default value given by the EDD and/or the DP.

In step 130, semantic meanings 2b* of configuration parameters 2b in the instance 2a are determined. According to block 131, this may comprise obtaining the semantic meaning 2b* from a library where it is stored in association with the field device 2 and with a name of the configuration parameter 2b.

In step 140, values of configuration parameters 3b stored in association with the field device 2 and semantic meanings 3b* are obtained from a data store 3.

In step 150, each value obtained from the data store 3 is written to a configuration parameter 2b in the instance 2a whose semantic meaning 2b* matches the semantic meaning 3b* of the value. Herein, according to block 151, for one and the same configuration parameter 2b, a value obtained from the data store 3 may take precedence over a default value given by the EDD and/or the DP, and/or over a value obtained from the template T.

In the example shown in FIG. 1, in step 160, a user is prompted for input of a value of a configuration parameter 2b that is required for startup of the field device 2 but not provided by any of the EDD, the DP, the template T, and the data store 3, so as to avoid inadvertent omissions.

In step 170, the field device 2 is provisioned with the instance 2a of the configuration.

According to block 171, multiple field devices that are connected to a network 1a of the industrial plant 1 may be provisioned in bulk.

According to block 171a, the provisioning of the multiple field devices 2 with instances 2a of configurations is performed in response to a predetermined condition regarding a load on the network 1a being met.

In step 180, at least one industrial process is executed on the industrial plant 1 with the participation of the field device 2.

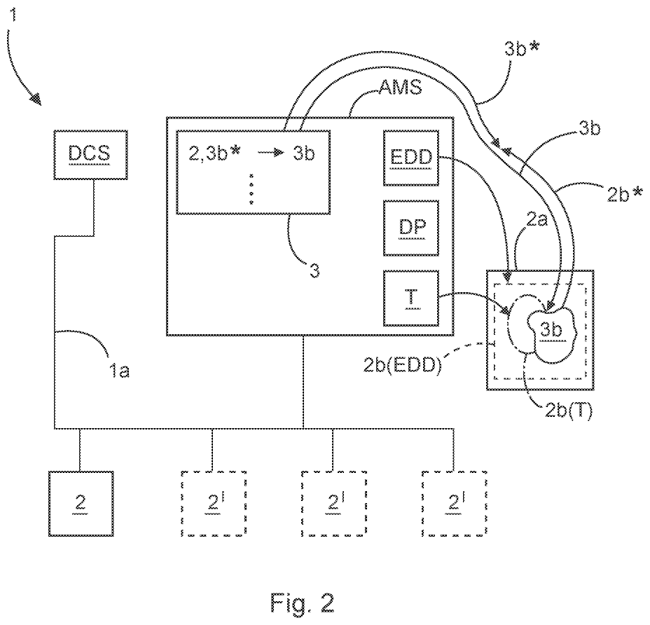

FIG. 2 illustrates an exemplary situation where the method 100 may be used. An industrial plant 1 comprises multiple field devices 2, 2′. The field devices 2, 2′, a distributed control system, DCS, and an asset management system, AMS, are connected to a network 1a of the industrial plant 1. The AMS houses a data store 3 in which values of configuration parameters 3b are stored in association with field devices 2, 2′ and semantic meanings 3b*. The AMS also stores Electronic Device Descriptions, EDD, and/or Device Packages, DP, as device description information for the field devices 2, 2′.

In the situation shown in FIG. 2, an instance 2a of a configuration for the field device 2 is created. The values of the configuration parameters 2b in this instance 2a are composed partly of values from the EDD and/or DP, partly of values from the template T, and partly of values from the data store 3. Values from the data store 3 are written to configuration parameters 2b in the instance 2a if the semantic meaning 3b* to which they are bound in the data store 3 matches the semantic meaning 2b* of the configuration parameter 2b in the instance 2a.

In a particularly advantageous embodiment, for one and the same configuration parameter, a value obtained from the template T takes precedence over a default value given by the device description information. As discussed above, the value from the template T is motivated by plant-specific knowledge and may therefore be more appropriate than a default value that is fixed without having regard to the concrete industrial plant in which the field device will be used.

Likewise, in a further particularly advantageous embodiment, for one and the same configuration parameter, a value obtained from the data store takes precedence over a default value given by the device description information, and/or over a value obtained from the template T. A value that has been fixed with the purpose of this one particular field device in mind is more likely to be appropriate than a value that has been fixed based on only generic knowledge about the industrial plant, or even without such knowledge.

In a further particularly advantageous embodiment, the determining of the semantic meaning comprises obtaining the semantic meaning from a library where it is stored in association with the field device and with a name of the configuration parameter. In the example mentioned above, if different field devices name a pressure set-point “pset”, “set-p” and “p-set-bar”, the library may store the semantic meaning “pressure set-point” in association with each field device and the respective name for the pressure set-point. One way of creating and using such a library is detailed in published co-pending application EP 3 929 673 A1.

In a further particularly advantageous embodiment, multiple field devices that are connected to a network of the industrial plant are provisioned in bulk. That is, one and the same data store may store values of configuration parameters for very many field devices, and the task of fixing the configuration parameters in the data store may be temporally uncoupled from the actual roll-out of the instances of configurations. For example, the roll-out may be performed at nighttime when it is less inconvenient that field devices may be temporarily nonfunctional while their configuration parameters are being updated. For example, updating certain configuration parameters may necessitate a reboot of the field device.

Another reason to perform the roll-out at a later time may be network load. That is, the provisioning of the multiple field devices with instances of configurations may be performed in response to a predetermined condition regarding a load on the network being met. In particular, if there is only limited bandwidth available, the provisioning may be performed at a time where less bandwidth is needed for the normal operation of the industrial plant. Also, the provisioning of different field devices may be scheduled to be performed at different times. If the field devices are connected to a network with a bus topology, this is a shared medium, and provisioning all field devices at the same time may cause congestion on this shared medium. Also, the scheduling may be modified to ensure that not too many field devices in certain sections of the plant are updated and momentarily unresponsive at exactly the same time, so that the section as a whole stays functional at all times.

Exemplary situations where there are bandwidth constraints include situations where the field device is connected to the network by means of a two-wire connection, and/or by means of a radio connection that is limited to a duty cycle of at most 1%. In particular, if there is a duty cycle limitation, a central management entity sending out instances of configurations to many field devices may exhaust its duty cycle very quickly and is then temporarily unable to send any further commands to field devices.

In a further particularly advantageous embodiment, a user is prompted for input of a value of a configuration parameter that is required for startup of the field device but not provided by any of the device description information, the template T, and the data store. In this manner, inadvertent omissions in the data store may be spotted before the instances of configurations are rolled out to field devices. For example, it may be avoided that a nightly rollout of a configuration with an omission of an important parameter renders the field device nonfunctional all night.

The field device may, in particular, be a device that is in direct physical interaction with an industrial plant, and/or with an industrial process executed on this industrial plant. In particular, the field device may be a sensor device that is to supply at least one measurement value of a physical quantity to a distributed control system, DCS, of the industrial plant, and/or an actor device that is to enact a control command received from the DCS on the plant.

In a particularly advantageous embodiment, the method steps described so far may be performed by an Asset Management System, AMS, of the industrial plant. Such an AMS may keep values of configuration parameters for all field devices on file in offline storage. In particular, the AMS may administer or even host the data store.

In a further advantageous embodiment, the method further comprises executing at least one industrial process on the industrial plant with the participation of the new field device. In this context, the method provides the advantage that the industrial process is more reliable because it is more likely that all field devices in the industrial plant actually run with the intended values of the configuration parameters that are stored in the data store. Also, the risk that the industrial process is interrupted due to important omissions in configurations is reduced.

The method is computer-implemented and can therefore be embodied in software. The invention therefore also provides computer program, comprising machine-readable instructions that, when executed on one or more computers and/or compute instances, cause the one more computers and/or compute instances to perform the method described above. In particular, process controllers, microcontrollers and other electronic devices that are able to execute machine-readable instructions may be regarded as computers as well. Compute instances comprise virtual machines, containers and any other execution environments in which machine-readable instructions may be executed. The invention also relates to a machine-readable data carrier, and/or a download product, with the computer program. A download product is a product that may be sold in an online shop for immediate fulfillment by download. The invention also provides one or more computers and/or compute instances with the one or more computer programs, and/or with the one or more machine-readable data carriers and/or download products.

### LIST OF REFERENCE SIGNS

1 industrial plant
2, 2′ field devices
2a instance of configuration for field device 2
2b configuration parameters in instance 2a
2b* semantic meanings of configuration parameters 2
3 data store
3b configuration parameters in data store 3
3b* semantic meanings of configuration parameters 3b
100 method for configuring field device 2
110 creating instance 2a
120 setting configuration parameters 2b to default values
130 determining semantic meanings 2b* of configuration parameters 2b
140 obtaining configuration parameters 3b from data store 3
150 writing values from data store 3 if semantic meanings 2b*, 3b* match
160 prompting user for missing value of configuration parameter 2b
170 provisioning field device with instance 2a of configuration
171 provisioning multiple field devices 2 in bulk
171a provisioning in response to condition regarding load on network 1a
180 executing industrial process on industrial plant 1
AMS asset management system
EDD electronic device description
DCS distributed control system
DP device package
T template configuration

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for configuring a field device for use in an industrial plant, comprising:
creating, from device description information of the field device, and/or from a template configuration, T, stored in association with the field device and/or in association with a type of the field device, an instance of a configuration for the field device;
setting values of configuration parameters in the instance to default values given by the device description information, and/or to values given by the template T;
determining semantic meanings of configuration parameters in the instance;
obtaining, from a data store, values of configuration parameters stored in association with the field device and semantic meanings;
writing each value obtained from the data store to a configuration parameter in the instance whose semantic meaning matches the semantic meaning of the value; and
provisioning the field device with the instance of the configuration.

2. The method of claim 1, wherein the device description information comprises an Electronic Device Description, EDD, and/or a Device Package, DP, of the field device.

3. The method of claim 1, wherein, for one and the same configuration parameter, a value obtained from the template T takes precedence over a default value given by the device description information.

4. The method of claim 1, wherein, for one and the same configuration parameter, a value obtained from the data store takes precedence over a default value given by the device description information, and/or over a value obtained from the template T.

5. The method of claim 1, wherein the determining of the semantic meaning comprises obtaining the semantic meaning from a library where it is stored in association with the field device and with a name of the configuration parameter.

6. The method of claim 1, wherein multiple field devices that are connected to a network of the industrial plant are provisioned in bulk.

7. The method of claim 6, wherein the provisioning of the multiple field devices with instances of configurations is performed in response to a predetermined condition regarding a load on the network being met.

8. The method of claim 1, further comprising prompting a user for input of a value of a configuration parameter that is required for startup of the field device but not provided by any of the device description information, the template T, and the data store.

9. The method of claim 1, wherein the field device is a device that is in direct physical interaction with an industrial plant, and/or with an industrial process executed on this industrial plant.

10. The method of claim 9, wherein the field device is a sensor device that is disposed to supply at least one measurement value of a physical quantity to a distributed control system, DCS, of the industrial plant, and/or an actor device that is to enact a control command received from the DCS on the plant.

11. The method of claim 1, wherein the method steps of creating and provisioning are performed by an Asset Management System, AMS, of the industrial plant.

12. The method of claim 1, further comprising executing at least one industrial process on the industrial plant with the participation of the field device.

13. A computer that includes a storage device containing computer executable instructions in tangible form that, when executed, perform functions comprising:
creating, from device description information of a field device, and/or from a template configuration, T, stored in association with the field device and/or in association with a type of the field device, an instance of a configuration for the field device;
setting values of configuration parameters in the instance to default values given by the device description information, and/or to values given by the template T;
determining semantic meanings of configuration parameters in the instance;
obtaining, from a data store, values of configuration parameters stored in association with the field device and semantic meanings;
writing each value obtained from the data store to a configuration parameter in the instance whose semantic meaning matches the semantic meaning of the value; and
provisioning the field device with the instance of the configuration.

14. The computer claim 13, wherein the device description information comprises an Electronic Device Description, EDD, and/or a Device Package, DP, of the field device.

15. The computer of claim 13, wherein, for one and the same configuration parameter, a value obtained from the template T takes precedence over a default value given by the device description information.

16. The computer of claim 13, wherein, for one and the same configuration parameter, a value obtained from the data store takes precedence over a default value given by the device description information, and/or over a value obtained from the template T.

17. The computer of claim 13, wherein the determining of the semantic meaning comprises obtaining the semantic meaning from a library where it is stored in association with the field device and with a name of the configuration parameter.

18. The computer of claim 13, wherein multiple field devices that are connected to a network of the industrial plant are provisioned in bulk.

19. The computer of claim 18, wherein the provisioning of the multiple field devices with instances of configurations is performed in response to a predetermined condition regarding a load on the network being met.

20. The computer of claim 13, further comprising prompting a user for input of a value of a configuration parameter that is required for startup of the field device but not provided by any of the device description information, the template T, and the data store.
